(19) United States
(12) Patent Application Publication
(10) Pub. No.: US 2012/0323742 A1
(43) Pub. Date: Dec. 20, 2012

(54) Method and system for brokering services with time-dependent labor rates

(76) Inventor: Shahryar Jamshidi, San Jose, CA (US)

(21) Appl. No.: 13/573,125

(22) Filed: Aug. 24, 2012

Related U.S. Application Data
(62) Division of application No. 12/804,841, filed on Jul. 30, 2010.

(51) Int. Cl. G06Q 30/00

(52) U.S. Cl. 705/27.1

(57) ABSTRACT

Service Providers (SPs) enter on a Broker Website a profile of their services, workdays, and Daily Labor Rates (DLRs). Users access the Website, and enter services they require, and when. The Website displays the identities, profiles, and DLRs of SPs who can do the required work during the User's time window. SPs set DLRs, directly or via criteria by which the Website calculates them, including by applying a Discount for Days Out from the present day. The User selects a SP and requests a booking for a date, locking in the DLR, if accepted. Once the work is completed, the SP bills the User, and is paid, through the Broker Website.

The invention also allows an individual to use an enabled mobile communication device to show his presence at a particular time and place, including to establish his presence at the agreed time and place for performance of Brokered services.

### PRIORITY

This is a Divisional application of, and claims priority from, application Ser. No. 12/804,841, filed Jul. 30, 2010, by the same sole inventor, Shahryar Jamshidi.

### FIELD OF THE INVENTION

The field of the invention is methods and systems for brokering services of Service Providers to Users of those services, more specifically for online computerized brokering of services of mobile or stationary Service Providers with time-dependent labor rates to Users in their service areas.

### BACKGROUND OF THE INVENTION

Service Providers struggle to fill up their schedules with jobs. Their livelihood depends on having work at the present time, and also knowing that they will have work in the future. A frequent additional challenge is making sure that the Users on their schedule actually show up for the job, so they can perform the scheduled work and be paid for it.

At the same time, potential Users generally look for the lowest available price consistent with the importance they place on the time frame for getting the job done. A User with a leaking water pipe is likely to place a very high premium on getting the repair work done as soon as possible, meaning both wanting a way to find an immediately available Service Provider, and being willing to pay a higher price than he might if he could afford to wait several days for the work to be done. Conversely, a User whose problem is less pressing is likely to be more willing to wait a while for the work to be done, and to expect to pay commensurately less for the work. In addition, Users would also like to be able to enforce the terms of the service agreement if the other party fails to show up at the appointed time and place to do the work.

What is needed is a method and system that allows a User to locate and arrange to obtain the services of a Service Provider in the area who is available to perform the required work on a schedule that fits the urgency, or lack of it, of the User's need, and that also allows the User to search for and obtain the best available pricing, consistent with that level of urgency. What is also needed is a method and system of assisting the User or the Service Provider in obtaining relief if the other party fails to show up at the agreed time and place set for performance of the work.

### SUMMARY OF THE INVENTION

Many time-related factors influence the prices to be charged to Users by Service Providers for desired services, including such differences as whether a User booking is made on an emergency basis (i.e., when the services are needed very soon, often on the same day the booking is requested), or several days in advance of when the work is to be done; whether the current state of the economy is good (in which case Service Providers may be willing to discount work that can be planned further ahead, as compared to work that must be done on a short-term basis, as above), or bad (in which case service providers may be anxious to nail down work now, and so make it less expensive for Users who are willing to go ahead and get the work done right away, as compared with Users who delay getting the work done); and whether the work is desired to be done on, say, a holiday or a weekend, or on a day when numerous prior bookings exist, making the latest User difficult to fit in.

This invention enables Service Providers (SPs) to display their time-variable labor rates to Users, helping to fill their present and future work schedules, based on the way they choose to discount their Daily Labor Rate (DLR) on various future days, as compared to what they would charge for such services on the present day. The invention displays the Service Providers and their variable labor rates to Users—potential customers for their services—and permits a User to request a booking with a particular Service Provider for a specific date and time, locking in the displayed labor is rate for the agreed performance date. The method works as follows.

Service Providers enroll as such on the invention's dedicated Broker Website, accessible on a public network, and input their Regular Workdays (defined as the present and future days on which a SP would typically be at work and available to perform their offered services) and regular hours, setting their Daily Labor Rates on each of those Regular Workdays. Users enroll as such on the Broker Website, and input the types of services they require, and the time window in which they desire to have them performed.

The Broker Website then displays to the User a listing and profiles of those Service Providers that have Regular Workdays during the User's defined time window, and those SPs' variable DLRs for those Regular Workdays. The DLRs shown on the Broker Website are set by the Service Providers, either by directly inserting them into the Website, or by designating criteria by which the Website's computer can automatically calculate them. One way the Service Provider can do the latter is to establish a “Discount for Days Out” (DFDO) going forward from the First Regular Workday, defined as the day a User consults the listing, if that day is a Regular Workday, or, if that day is not a Regular Workday, the first upcoming Regular Workday.

This Discount for Days Out, in a normal, growing economy, is positive, i.e., the DLR falls by the DFDO each Regular Workday, until a preset lowest DLR is reached. In a recessionary economy, the Service Provider can set a negative DFDO, so that the DLR rises by the DFDO each Regular Workday, until a preset maximum DLR is reached. In this way, the Service Provider can, in normal economic times, assure that future days will be filled, by allowing Users to realize a discount if they are willing to wait a while to have the work done; but, in slow times, can give Users an incentive to get the work done as soon as possible, by causing the DLR to rise in the future, compared to the present day.

The Service Provider can also set up the parameters for a DFDO calculation of DLR for each day, but then cause the computer to interrupt this calculation, display an arbitrarily-set DLR for some defined period of time, and then resume the DFDO calculations after the last day of that set DLR period, returning to start the DFDO calculation from the last previous calculated DLR.

After being presented with the list of Service Providers and their time-variable DLRs, the User selects a Service Provider and requests, through the Broker Website, a booking with the selected Service Provider for a specified date and time, locking in a labor rate on the agreed performance date, subject to the Service Provider's acceptance of the booking. If the booking is accepted, often after further communication between User and Service Provider about alternate times and/or dates for performance of the work, an agreement is reached for performance of the work at a specific date, time, and place, at the applicable Daily Labor Rate.

When the work is completed, the Service Provider so notifies the Broker Website, and submits a bill for the services performed, to be paid by the User. The User can pay the Service Provider's bill via the Website by any standard mechanism, including credit or debit card. The Broker Website then remits the payment, generally less a service charge, to the Service Provider.

The invention also includes a way for an individual to demonstrate his physical presence at a particular time and place, including the situation when proof of such presence will demonstrate his having shown up at an appointed time and place for performance of an agreed service brokered through a Broker Website. In this method, the individual carries a mobile communication device that can track the location of the device, and simultaneously detect selected biometric parameters of the individual carrying it, and transmit these data together to a remote computer. The computer, previously loaded with the corresponding biometric data for registered persons, records the location and biometric data from the device, as well as the time at which the signal from the device was sent, and can thereby determine the physical location of the mobile communication device at that time, and, by comparison of the transmitted biometric data with that loaded earlier, verify that a particular registered individual was present at a specified location at the time of transmission of the signal. This allows, in one embodiment, either party to a service contract entered into through the Broker Website, the User or the Service Provider, to transmit such data to the Broker Website, and establish that party's presence at the agreed time and place for performance of the work, in case the other party doesn't show up.

### BRIEF DESCRIPTION OF THE SEVERAL VIEWS OF THE DRAWING

FIG. 1 illustrates various conditions that cause time-dependent variations in Daily Labor Rates for Service Providers.

FIG. 2 illustrates the process by which a Service Provider sets up the system to apply the present method to set and display Daily Labor Rates for his Regular Workdays, present and future.

FIG. 3 illustrates the process by which a User inputs to the system the type of work and desired time window for its performance, views a list of SPs and their respective DLRs, selects a Service Provider and desired date and time for performance of the work, and requests a booking for that date and time, locking in the Daily Labor Rate for the date selected, subject to the Service Provider accepting the requested booking, and the Service Provider then accepts or rejects the requested booking.

FIG. 4A illustrates the way the system is set up to allow it to establish the physical presence of an individual at a relevant time and place.

FIG. 4B illustrates the use of the system by a User or Service Provider who is party to a brokered service agreement, to establish that that party kept his end of the agreement for services by showing up at the appointed time and place for performance, if the other party did not do so.

### DETAILED DESCRIPTION OF THE INVENTION AND DRAWINGS

The present invention comprises a method and system to allow a plurality of Service Providers (SPs) to display to a plurality of Users who require the Service Providers' offered services, on a dedicated Broker Website accessible to Service Providers and Users over a public network, the Service Providers' respective profiles of available services, and a calendar showing the Regular Workdays on which they would typically be available to perform those services, and their respective Daily Labor Rates (DLRs) on those Regular Workdays, including the time-dependent variation of those DLRs.

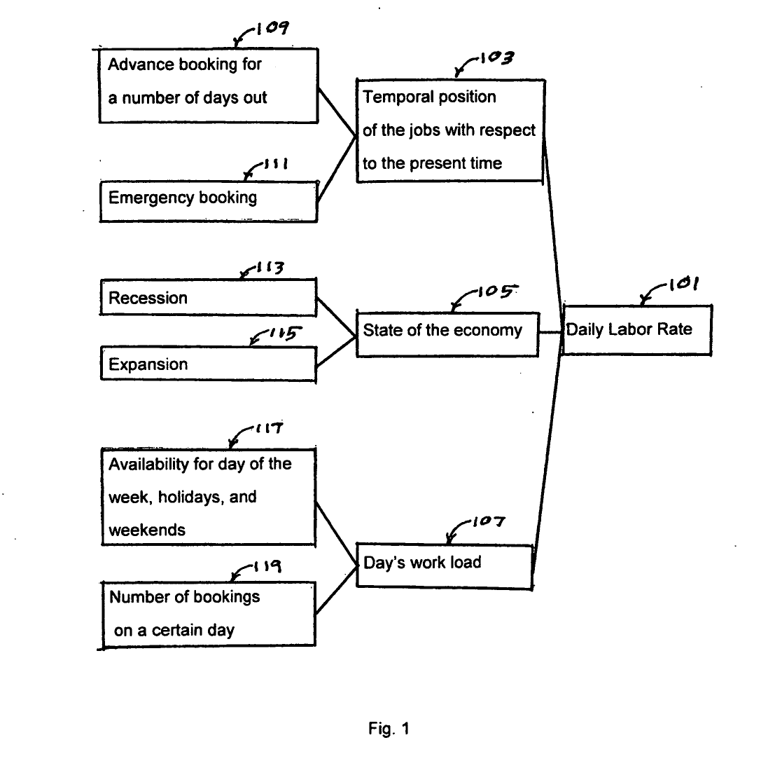

Numerous factors affect the labor rates charged by Service Providers, some within the control of the SP, and some not. FIG. 1 illustrates some of these factors. The labor rate 101 for a given day is influenced by the several factors shown. First, the temporal position 103 of the jobs with respect to the present time—how quickly the User needs or wants to have the work done. On an advanced booking for a number of days out 109 the labor rate will generally be significantly lower than for a job that must be booked and performed on an emergency basis 111, not only because the User is willing to pay more for the emergency job, but also because the Service Provider has more flexibility in terms of scheduling the routine job—fitting it in with his other scheduled work, obtaining the required labor and materials, etc. A second factor is the state of the economy 105. When the economy is in a healthy, growing, condition 115, Service Providers are generally willing to discount the labor rate for days out from the present day (i.e., give a positive Discount for Days Out, or DFDO, on the Daily Labor Rate), both because of the absence on those later days of the conditions that support the emergency pricing discussed above, and because by allowing Users to benefit pricewise from the work being done on a less urgent basis, the SP can capture as customers Users who might be less interested if they were only able to buy his services at his maximum daily labor date. However, when the economy is in a weaker, recessionary, condition 113, the Service Provider may actually choose to start out at a low rate, and then increase the labor rate for days out from the present (i.e., apply a negative DFDO), to give users a strong incentive to make a decision to go ahead and buy the services now, filling up the SP's present and near-future days, at a time when he is most anxious to capture new business. A third factor is the availability of the Service Provider to take on more work on any given day. Two aspects of this dependence on the day's work load 107 are the willingness of the SP to make into Regular Workdays, temporarily or permanently, days which would not normally be so, e.g., holidays and weekends 117, and the SPs handling of days on which the number of previous bookings for the day in question render it much more difficult for the SP to fit in the performance of work desired by a User 119. In both cases, SPs may desire to charge, and Users may be willing to pay, higher labor rates, both in recognition of the common unavailability of many or most SPs on such days, and because the SP's decision to make himself available, despite the reasons to the contrary, permits User-needed work to be done sooner than would otherwise be the case.

A computerized on-line method for brokering the labor of Service Providers to Users who require their services, includes the following steps:

a. Providing a digital computer server that has the required resources of processing devices, memory storage, and user input and output devices, that has a connection to a public network, and that is programmed with computer instructions, to carry out the following steps.

b. Creating on that server a Broker Website, and permitting Service Providers to access that Broker Website over a public network, to enroll on the Broker Website as Service Providers, and to offer their services to Users who access the Broker Website.

c. Storing in computer memory the profiles of enrolled Service Providers, including their respective offered services, their present and future Regular Workdays—the days and times on which they would ordinarily be available to perform the listed services—and the time-dependent Daily Labor Rates (DLRs) that they will be charging for services performed on each of those Regular Workdays.

d. Permitting Users, persons or businesses who are seeking services of the types offered by the enrolled Service Providers on the Broker Website, to access the Broker Website over the public network, to enroll as Users on the Broker Website, and to designate the classes of services they desire to purchase, and a time window—a range of dates—during which they wish to have the desired services performed.

e. Displaying to the enrolled User who has designated such desired services and a time window for their performance, a listing and the profiles of those Service Providers that offer, on Regular Workdays falling within the User-designated time window, the services designated by the User, along with those Service Providers' respective applicable DLRs on each such indicated Regular Workday.

f. Permitting the enrolled User to select a listed Service Provider, and to enter on the Broker Website a request for a booking with that Service Provider for performance of the desired work at a requested time on a selected Regular Workday, thereby locking in the Daily Labor Rate that will apply if the selected Service Provider accepts a booking to perform the desired services on the selected date.

g. Permitting the selected Service Provider to log in to the Broker Website, to receive the User's booking request, to communicate with the User if necessary to select a mutually agreeable time on the selected date for performance of the work, if the User's initially requested time is not available for any reason, and to communicate to the User the acceptance or rejection of the booking, locking in the displayed DLR for the selected date when the booking for that date is accepted.

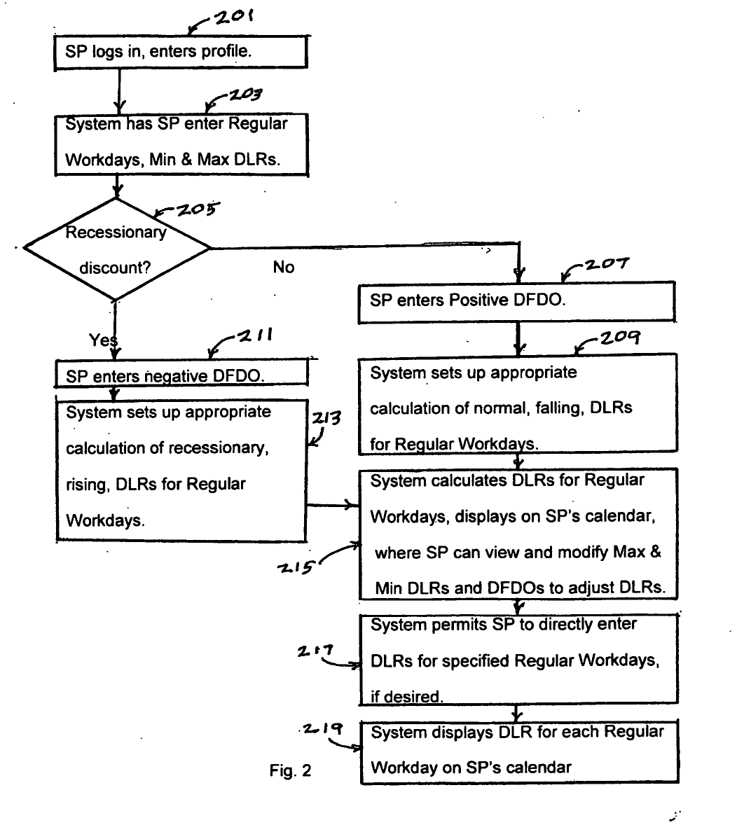

FIG. 2 illustrates the manner in which a Service Provider sets up his participation with the Broker Website. First 201, the Service Provider logs in to the system, enrolls as a Service Provider, generally paying the Broker Website an enrollment fee to do so, and enters his profile, showing the sorts of work he is qualified and offering to perform, and then 203 enters his Regular Workdays, and the hours on those days, on which he plans to work, and, in the embodiment in which the SP enables the system to automatically calculate his Daily Labor Rates on the Regular Workdays, he enters his Minimum and Maximum DLRs, and the DFDO he wishes to apply to have the system calculate his DLRs for future Regular Workdays.

In so doing, the SP must decide 205 whether to apply a recessionary or a normal Discount for Days Out from the First Regular Workday. If normal 207, he enters a positive DFDO. If recessionary 211, he enters a negative DFDO. In either case, the system calculates the applicable DLRs for the Regular Workdays—in the normal case, 209, starting at the Maximum DLR on the First Regular Workday and reducing the labor rate by the DFDO for each following Regular Workday, until the Minimum DLR is reached, and assigning the Minimum DLR to that and all subsequent Regular Workdays; in the recessionary case, 213, starting at the Minimum DLR on the First Regular Workday, and increasing the labor rate by the absolute value of the (negative) DFDO for each following Regular Workday, until the Maximum DLR is reached, and assigning the Maximum DLR to that and all subsequent Regular Workdays. The system then 215 calculates and enters the calculated DLRs for all Regular Workdays on the Service Provider's labor rate calendar, and allows the SP to view and, if desired, modify the values used to perform those calculations. The system then permits the SP to modify the calendar 217. He can, for example, provide a fixed DLR for specific selected days, replacing the DLRs that would otherwise be calculated for those days using the DFDO. This might be done to raise the rate for a day or more on account of there being earlier bookings for those days; or to offer a lower sale price for a time, to attract more Users. Or, he can decide to insert a new Regular Workday on what was originally listed as a holiday on which he would not work, manually setting a new, likely higher, fixed DLR for that day. Once he completes making any such modifications, the system recalculates and displays 219 the revised DLRs for all Regular Workdays on the SP's calendar.

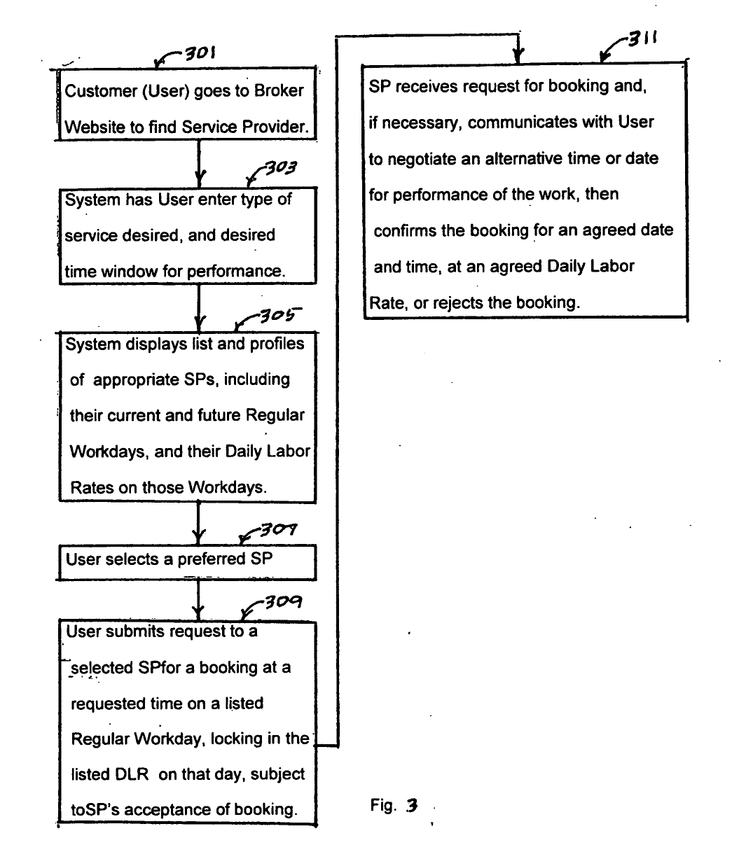

As illustrated in FIG. 3, in the instant method, Users log in and enroll as Users on the Broker Website, and are prompted to designate the class or classes of services that they need 301, and the time window in which they desire to have the services provided 303. Once a User has entered this data onto the Broker Website, the Website displays to the User 305 the identities and profiles of those Service Providers who do the sort of work required by the User, and who have Regular Workdays during the time period designated by the User, on which they would ordinarily be able to provide the needed services, along with the DLRs that will be charged by the respective Service Providers on their listed Regular Workdays. The User then selects a desired Service Provider 307, and submits to the SP, via the Website, a request for a booking at a requested time on a requested Regular Workday on the SP's calendar 309, locking in the DLR shown for that date in the event that the SP accepts the booking. The Service Provider receives the request for a booking, communicates with the requesting User if necessary to negotiate a different time or date than originally requested by the User, then confirms or rejects the booking 311, finalizing the agreement to perform the agreed work on the agreed date and time, at the applicable Daily Labor Rate for that day.

In one embodiment, enrolled Service Providers are permitted to log in to the Broker Website and directly set the applicable DLRs for all displayed Regular Workdays.

In an advantageous embodiment, enrolled Service Providers are permitted to log in to the Broker Website and set up criteria by which their respective time-dependent DLRs are automatically calculated by the server for a First Regular Workday (Again, “First Regular Workday” is defined as either the present day, if it is a Regular Workday, or, if the present day is not a Regular Workday, the first upcoming Regular Workday after the present day.) and for subsequent Regular Workdays.

In an especially advantageous embodiment described above in connection with FIG. 2, typically applicable in a growing economy, one or more Service Providers establish normal, falling, variable Daily Labor Rates for each listed Regular Workday, giving Users the opportunity to pay lower labor rates if they are willing to have the desired services performed on a less urgent basis, and keeping the Service Provider's calendar full well into the future, by establishing a Maximum DLR to be displayed for the First Regular Workday, and then calculating the DLR on subsequent Regular Workdays by applying a positive Discount for Days Out (DFDO) from the First Regular Workday, by the following steps:

a. Entering in the computer a Maximum DLR for the Service Provider's services.

b. Entering in the computer a Minimum DLR for the Service Provider's services, below which the discounted DLR will not be permitted to fall, no matter how many Regular Workdays out from the First Regular Workday.

c. Entering in the computer a positive Discount for Days Out (DFDO) for each Regular Workday out from the First Regular Workday.

d. When a User logs in to the Broker Website to perform a search for a Service Provider that provides the desired services, with Regular Workdays within the User's time window, and to see those Service Providers' DLRs on their Regular Workdays, present and future, displaying a DLR for each Regular Workday, calculated as follows:
(1) For the First Regular Workday, the Maximum DLR is displayed.
(2) For each subsequent Regular Workday, the displayed DLR is the previous Regular Workday's DLR minus the DFDO.
(3) When any Regular Workday's calculated DLR would be less than the Minimum DLR, the displayed DLR for that Regular Workday is the Minimum DLR.

e. At the end of each Regular Workday, the displayed DLR for the First Regular Workday is reset to the Maximum DLR, and step d. is repeated, calculating and displaying the new applicable DLRs for each subsequent Regular Workday.

(See discussion of FIG. 2, above, items 207, 209, and 215.)

In another advantageous embodiment discussed in connection with FIG. 2, above, typically applicable in a depressed economy, one or more Service Providers establish recessionary, rising, variable Daily Labor Rates for each listed Regular Workday, providing a price incentive to Users to get the desired work done sooner rather than later, and keeping the Service Provider as booked as possible on the present and immediate future days, by establishing a Minimum DLR to be displayed for the First Regular Workday, and then calculating the DLR on subsequent Regular Workdays by applying a negative Discount for Days Out (DFDO) from the First Regular Workday, causing the most attractive day, pricewise, to be the day the User logs in to the Broker Website, with prices rising thereafter, to encourage Users to contract for the desired services at the earliest practical date. This is accomplished by the following steps:

a. Entering in the computer a Minimum DLR for the Service Provider's services.

b. Entering in the computer a Maximum DLR for the Service Provider's services, above which the DLR will not be permitted to rise, no matter how many Regular Workdays out from the First Regular Workday.

c. Entering in the computer a negative Discount for Days Out (DFDO) for each Regular Workday out from the First Regular Workday.

d. When a User logs in to the Broker Website to perform a search for a Service Provider that provides the desired services, with Regular Workdays within the User's time window, and to see those Service Providers' DLRs on their Regular Workdays, present and future, displaying a DLR for each Regular Workday, calculated as follows:
(1) For the First Regular Workday, the Minimum DLR is displayed.
(2) For each subsequent Regular Workday, the displayed DLR is the to previous Regular Workday's DLR plus the absolute value of the negative DFDO.
(3) When any Regular Workday's calculated DLR would be greater than the Maximum DLR, the displayed DLR for that Regular Workday is the Maximum DLR.

e. At the end of each Regular Workday, the displayed DLR for the First Regular Workday is reset to the Minimum DLR, and step d. is repeated, calculating and displaying the new applicable DLRs for each subsequent Regular Workday. (See discussion of FIG. 2, above, items 211, 213, and 215.)

Typically, the DFDO in the above methods is either a preset monetary amount, or a preset percentage of the previous day's DLR. In another embodiment, the DFDO is itself calculated for each Regular Workday, as a function of the number of Regular Workdays out from the First Regular Workday.

In an embodiment of the above-described methods, an enrolled Service Provider is permitted to log on to the Broker Website and cause the computer to display, for a specified calendar time period, an arbitrarily chosen DLR rather than one calculated using the DFDO, after which specified time period the displayed rates resume being calculated based upon the DFDO and DLR in effect immediately before the specified time period. (See discussion of FIG. 2, above, item 217.)

In one embodiment, the selected Service Provider's acceptance or rejection of an enrolled User's request for a booking on a selected Regular Workday, at the Service Provider's specified labor rate for that date, is posted on the Broker Website, where it is displayed to the User when the User again logs on to the Broker Website.

Another advantageous embodiment includes the step of permitting a Service Provider from whom a booking is requested by a User on the Broker Website to communicate with the requesting User via the Broker Website to attempt to negotiate a booking for a different date and time than initially requested, locking in an agreed DLR for performance of requested services on the new agreed date and time. (See discussion of FIG. 3, above, item 311.)

Another advantageous embodiment includes the step of permitting a Service Provider from whom a booking is requested and the requesting User to communicate via the Broker Website to negotiate a booking in which the Service Provider provides a total estimated price for all services specified by User. Even if not a firm price, this gives the User a much clearer idea how much labor, and therefore how much expense, is likely to be involved in completing the job.

Yet another advantageous embodiment includes the step of permitting the Service Provider and the User to negotiate via the Broker Website a firm price quote for which the Service Provider commits to perform all services specified by the User. While the agreement may allow price adjustments based on unforeseen circumstances, changed scope requested later by the User, etc., a firm quote greatly eases the user's budget process, especially for very large jobs.

In another highly advantageous embodiment, once the agreed services are completed, the Service Provider is permitted to log on to the Broker Website and transmit to the Website a bill to the User for those services, which the User can access by logging on to the Broker Website.

In an especially advantageous embodiment the Broker Website, having received the bill from the Service Provider and communicated it to the contracting User, accepts payment from the User on behalf of the Service Provider. This payment can be made by any convenient method, including by credit or debit card.

In another advantageous embodiment, the Broker Website deducts a service change for handling the payment transaction before forwarding the User payment to the Service Provider.

In one embodiment, the method includes having one or more Service Providers enrolled on the Broker Website who are Mobile Service Providers, performing brokered services at the User's location. These Mobile Service Providers can be set up to communicate with the Broker Website and requesting Users via a mobile communication device, from their constantly changing locations.

In another embodiment, one or more Service Providers operate from set business locations, to which Users come to receive the Service Providers' brokered services once a booking is accepted.

A related method that is encompassed by this invention provides a way of verifying the physical location of an individual, at a given date and time. The method includes providing a digital computer, with required resources of processing devices, memory storage, user input and output devices, and connection to a public network, and programmed with computer instructions, for carrying out the following steps: storing selected biometric data on the individual, receiving and processing data transmitted to the computer by a mobile communication device carried by the individual, which device is capable of measuring and transmitting to the computer the simultaneous values of an accurate physical location of the mobile communication device, and corresponding biometric data on the individual carrying the device. The computer then compares the received biometric data with corresponding biometric data for the individual, previously stored on the computer, to verify the identity of the individual in possession of the mobile communication device. The transmitted location and biometric data are time-stamped upon receipt by the computer. In this way, the computer can verify the personal physical presence of the individual carrying the mobile communication device at a particular location at a relevant time. The Website's computer preferably has the capability to convert the location information transmitted by the mobile communication device, in the form of GPS coordinates, into the corresponding street address, if one exists.

The biometric data gathered by the mobile communication device and transmitted to the computer can be any form of information that allows a positive identification of the individual when compared to the previously stored corresponding data on the individual. Such information could include, without limitation, unique data from the individual's fingerprints, facial recognition parameters, a retinal scan, or DNA samples.

In an advantageous embodiment of the above method, the individual is a User or Service Provider who is a party to a service agreement, brokered by a Broker Website, providing that an agreed service is to be performed at a specified place and time, who carries the mobile communication device and uses it to send the location and biometric data, from the specified location, at the specified time, to the Broker Website. The website, on whose server the contracting party's biometric data was previously stored when the party registered with the Broker Website, can match the transmitted biometric data with the previously stored biometric data, and verify that the registered party was physically present at the place and time specified for performance of the agreed service.

In a particularly advantageous embodiment of the above method, the Broker Website records and retains the location and biometric data, sent to the Website by the party to the service agreement, and the time at which it was sent, in a form usable to document the presence of that party at the specified time and place for performance of the agreed service. This permits either party to a service agreement to have ready access to the proof of his physical presence at the time and place set for performance of the agreed service, and have it in a form that should prove difficult for the party who did not show up to challenge.

In a further advantageous embodiment of the above method, the Broker Website provides a written certification attesting to the presence of either contracting party carrying the mobile communication device at the specified time and place, in the event that the other party to the agreement failed to show up. This provides the party who did show up at the appointed time and place with solid evidence of that fact, which will render it difficult for the no-show contracting party to contest.

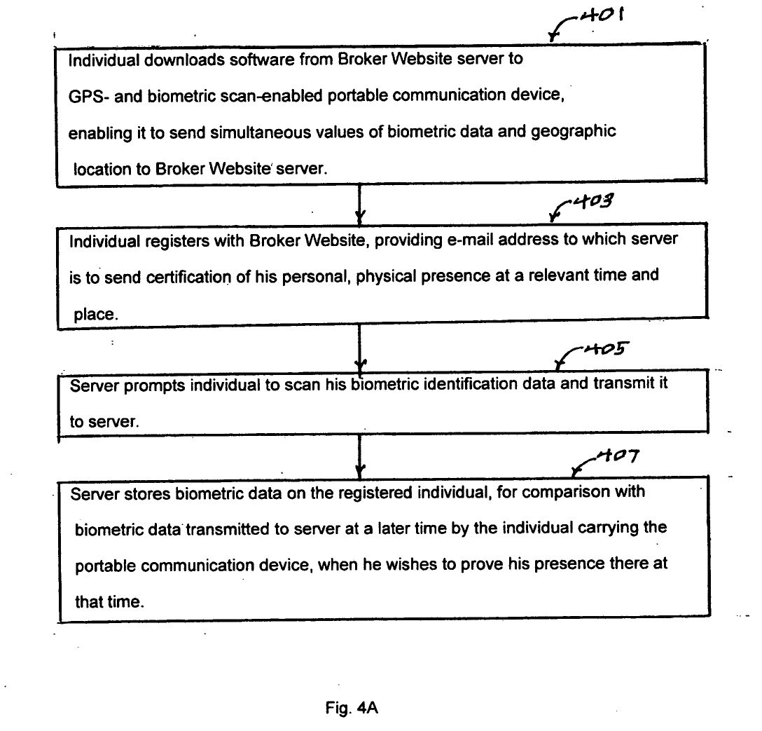

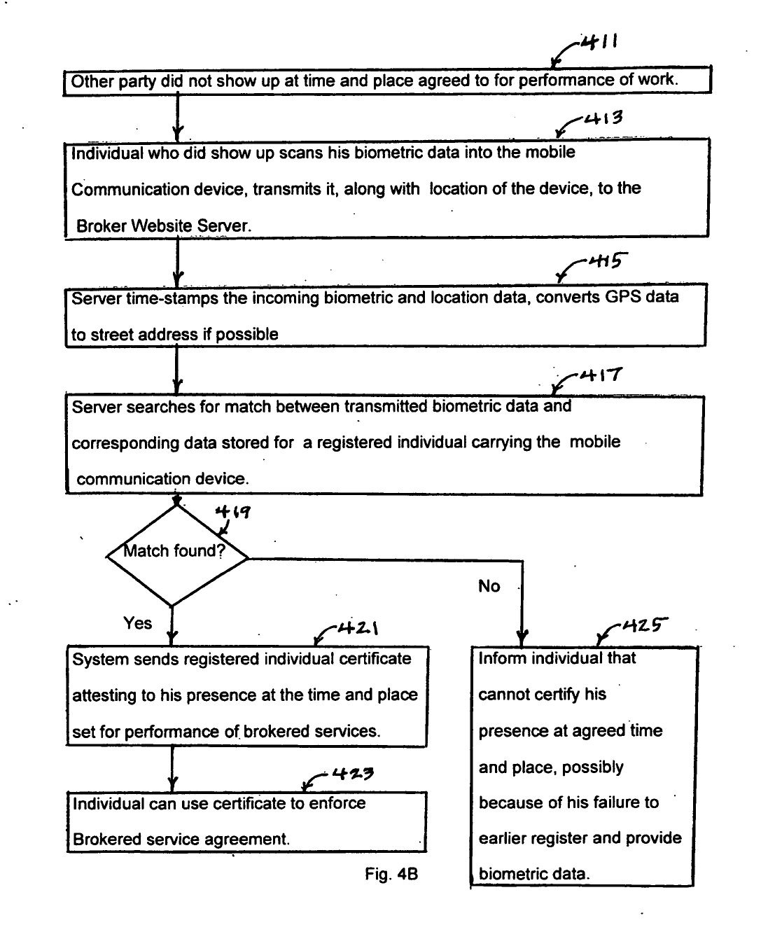

FIGS. 4A and 4B illustrate how this method and system work, including for an individual who is party to a service agreement set up by the Broker Website.

First, in FIG. 4A, an individual downloads 401 onto a mobile communication device, which has a GPS capable of accurately tracking its location, and which also has the capability to scan a biometric identifying characteristic of the individual, software from the Broker Website server that enables the device to transmit to the Broker Website server the simultaneous values of the scanned biometric data and the location of the device. The individual registers 403 with the Broker Website, and provides an e-mail or other address to which the Broker Website is to send a written certification that he was physically present at a relevant time and place. When prompted by the Website 405, the individual uses the enabled mobile communication device to send to the Website the identifiable biometric data on the individual, to which subsequently measured and transmitted corresponding biometric data will be compared. This biometric data is stored 407 on the Website's server for future reference.

Then, in FIG. 4B, if the other party to a brokered service agreement did not show up at the appointed time and place 411, the individual User or SP carrying the mobile communication device scans his biometric data into the device, and the device sends that data, along with the precise location of the device, to the Broker Website's server 413. The server time-stamps the receipt of the data 415 and searches for a match with biometric data stored for persons who registered with the Website and provided their data for this purpose 417. If the server finds that the received biometric data matches the stored data of the registered User or SP transmitting it 419, the Website sends to the address provided by that party a certification that he was at the transmitted location at the time of the transmission 421. That party can then use that certification to establish 423 that he showed up as agreed for the performance of the work, whereas the other party to the agreement did not. If the Website's server finds that the transmitted biometric data does not match that of the individual using the device, it will so inform the sender 425, indicating that it cannot certify the presence of the individual at the time and place set for performance of the work, possibly because the individual has not previously registered and provided his biometric identifying data to the Website's server.

The invention also encompasses the corresponding system for brokering labor of Service Providers to Users by applying the claimed method, which system includes:

a. A digital computer server, with required resources of processing devices, memory storage, user input and output devices, and connection to a public network, and programmed with computer instructions, for performing the following steps of the method.

b. Creating on the server a Broker Website, and permitting Service Providers to access the Broker Website over a public network, enroll on the Broker Website as Service Providers, and offer their services to Users on the Broker Website.

c. Storing in computer memory profiles of enrolled Service Providers, including their respective offered services, their present and future Regular Workdays, and their time-dependent labor rates to be charged on each of those Regular Workdays.

d. Permitting Users to access the Broker Website over the public network, to enroll as Users on the Broker Website, and to designate classes of services they desire to purchase, and a time window during which they wish the desired services to be performed.

e. Displaying to the enrolled User who has designated such desired services a listing and profiles of those Service Providers that offer, on Regular Workdays falling within the User-designated time window, the services designated by the User, and those Service Providers' respective applicable daily labor rates (DLRs) on each such Regular Workday,

f. Permitting the enrolled User to select a Service Provider, and enter on the Broker Website a request for a booking with that Service Provider for performance of the desired work at a requested time on a selected Regular Workday, thereby locking in the Daily Labor Rate that will apply if the selected Service Provider accepts a booking to perform the desired services on the selected date.

g. Permitting the selected Service Provider to log in to the Broker Website, to receive the User's booking request, to communicate with the User if necessary to select a mutually agreeable time on the selected date for performance of the work, and to communicate to the User the acceptance or rejection of the booking, locking in the displayed DLR for the selected date when the booking for that date is accepted.

In one embodiment of the above system, enrolled Service Providers are permitted to log in to the Broker Website and directly set applicable DLRs for a First Regular Workday and subsequent Regular Workdays.

In an advantageous embodiment of the system, enrolled Service Providers, in lieu of needing to individually set the DLRs for all displayed Regular Workdays, can log in to the Broker Website and set up criteria by which their respective time-dependent DLRs are automatically calculated for the First and subsequent Regular Workdays.

In an especially advantageous embodiment of the system, one or more Service Providers are able to establish normal, falling, variable Daily Labor Rates for Regular Workdays by the following steps.

a. The Service Provider enters in the computer a Maximum DLR for its services

b. The Service Provider enters in the computer a Minimum DLR for its services.

c. The Service Provider enters in the computer a positive Discount for Days Out (DFDO) for each Regular Workday out from the First Regular Workday.

d. When a User, who has provided the type of service required and the desired timeframe for performance of the service, logs in to the Broker Website to perform a search for a Service Provider, the site displays a DLR for each Regular Workday, calculated as follows:
(1) for the First Regular Workday, the Maximum DLR,
(2) for each subsequent Regular Workday, the previous Regular Workday's DLR minus the DFDO,
(3) when any Regular Workday's calculated DLR would be less than the Minimum DLR, the Minimum DLR.

e. At the end of each Regular Workday, the website resets the displayed DLR for the First Regular Workday to the Maximum DLR, and repeats step d., calculating and displaying the new applicable DLRs for each subsequent Regular Workday.

In another especially advantageous embodiment of the system, applicable mainly in times of economic distress, one or more Service Providers are able to establish recessionary, rising, variable Daily Labor Rates for Regular Workdays by the following steps.

a. The Service Provider enters in the computer a Maximum DLR for its services.

b. The Service Provider enters in the computer a Minimum DLR for its services.

c. The Service Provider enters in the computer a negative Discount for Days Out (DFDO) for each Regular Workday out from the First Regular Workday.

d. When a User, who has provided the type of service required and the desired timeframe for performance of the service, logs in to the Broker Website to perform a search for a Service Provider, the site displays a DLR for each Regular Workday, calculated as follows:
(1) for the First Regular Workday, the Minimum DLR,
(2) for each subsequent Regular Workday, the previous Regular Workday's DLR plus the absolute value of the negative DFDO,
(3) when any Regular Workday's calculated DLR would be greater than the Maximum DLR, the Maximum DLR. [symbol] individual, which device is capable of measuring and transmitting to the computer the simultaneous values of an accurate physical location of the mobile communication device, and biometric data on the individual measured by the device. The computer is able to compare the biometric data with corresponding biometric data previously stored on the computer, to verify the identity of the individual in possession of the mobile communication device. The transmitted location and biometric data are time-stamped upon receipt by the computer. As discussed above with respect to the method, the Website's computer includes the capability to convert the GPS location information transmitted by the mobile communication device into the corresponding street address, if one exists. In this way, the computer can verify the personal physical presence of the individual carrying the mobile communication device at a particular location at a relevant time.

In an advantageous embodiment of the above system, a User or Service Provider who is a party to a service agreement, brokered by a Broker Website, providing that an agreed service is to be performed at a specified place and time, carries the mobile communication device and can use it to send the location and biometric data, from the specified location, at the specified time, to the Broker Website. The website, on whose server the contracting party's biometric data was previously stored when the party registered with the Broker Website, can match the incoming biometric data with the previously stored biometric data, and verify that the registered party was physically present at the place and time specified for performance of the agreed service.

In a particularly advantageous embodiment of the above system, the Broker Website can record and retain the location and biometric data, sent to the Website by the party to the service agreement, and the time at which it was sent, in a form usable to document the presence of that party at the specified time and place for performance of the agreed service. This permits either party to a service agreement to have ready access to the proof of his physical presence at the time and place set for performance of the agreed service.

In an advantageous embodiment of the above system, the computer on which the Broker Website resides is able to provide a written certification attesting to the contracting party's presence at the appointed time and place, in the event that the other party to the agreement failed to show up.

The present invention also encompasses a computer program product stored on machine-readable media, the product comprising machine executable instructions enabling a digital computer server, with required resources of processing devices, memory storage, user input and output devices, and connection to a public network, to broker labor of Service Providers to Users, by carrying out the steps of:

a. creating on the server a Broker Website, and permitting Service Providers to access the Broker Website over a public network, enroll on the Broker Website as Service Providers, and offer their services to Users on the Broker Website,

b. storing in computer memory profiles of enrolled Service Providers, including their respective offered services, their present and future Regular Workdays, and their time-dependent labor rates to be charged on each of those Regular Workdays,

c. permitting Users to access the Broker Website over the public network, to enroll as Users on the Broker Website, and to designate classes of services they desire to purchase, and a time window during which they wish the desired services to be performed,

d. displaying to the enrolled User who has designated such desired services a listing and profiles of those Service Providers that offer, on Regular Workdays falling within the User-designated time window, the services designated by the User, and those Service Providers' respective applicable daily labor rates (DLRs) on each such Regular Workday,

e. permitting the enrolled User to select a Service Provider, and enter on the Broker Website a request for a booking with that Service Provider for performance of the desired work at a requested time on a selected Regular Workday, thereby locking in the Daily Labor Rate that will apply if the selected Service Provider accepts a booking to perform the desired services on the selected date,

f. permitting the selected Service Provider to log in to the Broker Website, to receive the User's booking request, to communicate with the User if necessary to select a mutually agreeable time on the selected date for performance of the work, and to communicate to the User the acceptance or rejection of the booking, locking in the displayed DLR for the selected date when the booking for that date is accepted.

In an advantageous embodiment of the above computer software program product the program permits enrolled Service Providers to log in to the Broker Website and set up criteria by which their respective time-dependent DLRs are automatically calculated for a First Regular Workday and for subsequent Regular Workdays.

In a particularly advantageous embodiment of the above computer software program, the criterion for calculating DLRs for Regular Workdays comprises setting an Initial DLR for the First Regular Workday, a Discount for Days Out (DFDO) to be applied to new Regular Workdays, and a Final DLR which the calculated DLR is not permitted to go beyond from the initial rate. For normal economy pricing, the Initial DLR is the Maximum DLR, the DFDO is positive, and the Final DLR is the Minimum DLR. By contrast, for recessionary pricing the initial DLR is the Minimum DLR, the Discount for DFDO is negative, and the final DLR is the Maximum DLR. The program calculates the DLR for each Regular Workday following the First Regular Workday is by subtracting the (positive or negative) DFDO from the preceding Regular Workday's DLR, until the Regular Workday when the Final DLR is reached, and assigning the Final DLR to that and any subsequent Regular Workdays.

The present invention also encompasses a computer program product stored on machine-readable media, the product comprising machine executable instructions enabling a digital computer server, with required resources of processing devices, memory storage, user input and output devices, and connection to a public network, to verify the physical location, at a given date and time, of an individual, based upon receiving and processing data transmitted to the computer by a mobile communication device carried by the individual. The device transmits simultaneous values of an accurate physical location of the mobile communication device, and biometric data on the individual measured by the device. The computer receives this data, and compares the received biometric data with corresponding biometric data on the individual previously stored on the computer, to verify the identity of the individual in possession of the mobile communication device. The data is time-stamped upon receipt by the computer, whereby the computer can verify the individual's personal physical presence at a particular location at a relevant time.

In a particularly advantageous embodiment of the above computer program product, the individual carrying the mobile communication device is a User or Service Provider who is a party to a service agreement brokered by a Broker Website, such agreement providing that an agreed service is to be performed at a specified place and time. The individual uses the mobile communication device to send, from the specified location, at the specified time, a message to the Broker Website, on whose server the contracting party's biometric data was previously stored when the party registered with the Broker Website, the party's GPS location and biometric data. The computer time-stamps such data upon receipt, and compares the received and previously stored biometric data to verify that the party was physically present at the place and time specified for performance of the agreed service

Also encompassed by the present invention is the computer software product, stored on machine-readable media, and comprising machine executable instructions enabling a digital computer server, with required resources of processing devices, memory storage, user input and output devices, and connection to a public network, to broker labor of Service Providers to Users, by carrying out the steps of:

a. The computer stores in its memory a Broker Website, and permits Service Providers to access the Broker Website over a public network, enroll on the Broker Website as Service Providers, and offer their services to Users on the Broker Website.

b. The computer also stores in its memory profiles of enrolled Service is Providers, including their respective offered services, their present and future Regular Workdays, and their time-dependent Daily Labor Rates to be charged on each of those Regular Workdays.

c. The computer Permits Users to access the Broker Website over the public network, to enroll as Users on the Broker Website, and to designate classes of services they desire to purchase, and a time window during which they wish the desired services to be performed.

d. The computer displays to the enrolled User who has designated such desired services a listing and profiles of those Service Providers that offer, on Regular Workdays falling within the User-designated time window, the services designated by the User, and those Service Providers' respective applicable Daily Labor Rates (DLRs) on each such Regular Workday,

e. The computer permits the enrolled User to select a Service Provider, and enter on the Broker Website a request for a booking with that Service Provider for performance of the desired work at a requested time on a selected Regular Workday, thereby locking in the Daily Labor Rate that will apply if the selected Service Provider accepts a booking to perform the desired services on the selected date.

f. The computer permits the selected Service Provider to log in to the Broker Website, to receive the User's booking request, to communicate with the User if necessary to select a mutually agreeable time on the selected date for performance of the work, and to communicate to the User the acceptance or rejection of the booking, locking in the displayed DLR for the selected date when the booking for that date is accepted.

In an advantageous embodiment, the computer software product also permits enrolled Service Providers to log in to the Broker Website and set up criteria by which their respective time-dependent DLRs are automatically calculated for a First Regular Workday and for subsequent Regular Workdays, rather than needing to all be manually set, and those automatically calculated DLRs are displayed to the User selecting a SP.

In an especially advantageous embodiment, the criterion referenced in the preceding paragraph for calculating DLRs for Regular Workdays comprises setting an initial DLR (which for the normal economy, positive DFDO, calculation is the Maximum DLR; and for the recessionary, negative DFDO, calculation is the Minimum DLR) for the First Regular Workday; setting a Discount for Days Out (DFDO) (which is positive in the normal economy case; negative in the recessionary case), and setting a Final DLR (which is the Minimum DLR in the normal case; and is the Maximum DLR in the recessionary case), then calculating the DLR for each Regular Workday following the First Regular Workday by subtracting the DFDO (positive in the normal case, and negative—the subtraction of which equates to addition of the absolute value of the negative DFDO—in the recessionary case) from the preceding Regular Workday's DLR, until the preset Final DLR is reached, and assigning the Final DLR to that and any subsequent Regular Workdays.

Additionally encompassed in the invention is the computer software product, also stored on machine-readable media, and comprising machine executable instructions enabling a digital computer server, with required resources of processing devices, memory storage, user input and output devices, and connection to a public network, to verify the physical location of an individual at a given date and time, by carrying out the following steps:

a. The computer stores selected biometric data on the individual.

b. The computer receives and processes data transmitted to it by a mobile communication device carried by the individual, and capable of measuring and transmitting to the computer a signal encompassing simultaneous values of an accurate physical location of the mobile communication device, and corresponding biometric data on the individual measured by the device.

c. The computer compares the received biometric data with the corresponding biometric data on the individual previously stored on the computer, verifying the identity of the individual in possession of the mobile communication device.

d. The computer time-stamps the location and biometric data upon receipt.

e. The computer thereby verifies the individual's personal physical presence at the known location of the mobile communication device at the time of the transmission.

What is claimed is:

1. A computerized on-line method for brokering labor of Service Providers to Users, comprising the steps of:
a. providing a digital computer server, with required resources of processing devices, memory storage, user input and output devices, and connection to a public network, and programmed with computer instructions, for performing the following steps,
b. creating on the server a Broker Website, and permitting Service Providers to access the Broker Website over a public network, enroll on the Broker Website as Service Providers, and offer their services to Users on the Broker Website,
c. storing in computer memory profiles of enrolled Service Providers, including their respective offered services, their present and future Regular Workdays, and their time-dependent Daily Labor Rates to be charged on each of those Regular Workdays,
d. permitting Users to access the Broker Website over the public network, to enroll as Users on the Broker Website, and to designate classes of services they desire to purchase, and a time window during which they wish the desired services to be performed,
e. displaying to the enrolled User who has designated such desired services a listing and profiles of those Service Providers that offer, on Regular Workdays falling within the User-designated time window, the services designated by the User, and those Service Providers' respective applicable daily labor rates (DLRs) on each such Regular Workday,
f. permitting the enrolled User to select a Service Provider, and enter on the Broker Website a request for a booking with that Service Provider for performance of the desired work at a requested time on a selected Regular Workday, thereby locking in the Daily Labor Rate that will apply if the selected Service Provider accepts a booking to perform the desired services on the selected date,
g. permitting the selected Service Provider to log in to the Broker Website, to receive the User's booking request, to communicate with the User if necessary to select a mutually agreeable time on the selected date for performance of the work, and to communicate to the User the acceptance or rejection of the booking, locking in the displayed DLR for the selected date when the booking for that date is accepted.

2. The method of claim 1, wherein enrolled Service Providers are permitted to log in to the Broker Website and directly set applicable DLRs for all displayed Regular Workdays.

3. The method of claim 1, wherein enrolled Service Providers are permitted to log in to the Broker Website and set up criteria by which their respective time-dependent DLRs are automatically calculated for a First Regular Workday and for subsequent Regular Workdays.

4. The method of claim 3, wherein one or more Service Providers establish normal, falling, variable Daily Labor Rates for Regular Workdays by the following steps:
a. entering in the computer a Maximum DLR for the Service Provider's services,
b. entering in the computer a Minimum DLR for the Service Provider's services,
c. entering in the computer a positive Discount for Days Out (DFDO) for each Regular Workday out from the First Regular Workday,
d. when a User logs in to the Broker Website to perform a search for a Service Provider, displaying a DLR for each Regular Workday, calculated as follows:
(1) for the First Regular Workday, the Maximum DLR,
(2) for each subsequent Regular Workday, the previous Regular Workday's DLR minus the DFDO,
(3) when any Regular Workday's calculated DLR would be less than the Minimum DLR, the Minimum DLR, and,
e. at the end of each Regular Workday, resetting the displayed DLR for the First Regular Workday to the Maximum DLR, and repeating step d, calculating and displaying the new applicable DLRs for each subsequent Regular Workday.

5. The method of claim 3, wherein one or more Service Providers establish recessionary, falling, variable daily labor rates (DLRs) for Regular Workdays by the following steps:
a. entering in the computer a Minimum DLR for the Service Provider's services,
b. entering in the computer a Maximum DLR for the Service Provider's services,
c. entering in the computer a negative Discount for Days Out (DFDO) for each Regular Workday out from the First Regular Workday,
d. when a User logs in to the Broker Website to perform a search for a Service Provider, displaying a DLR for each Regular Workday, calculated as follows:
(1) for the First Regular Workday, the Minimum DLR,
(2) for each subsequent Regular Workday, the previous Regular Workday's DLR plus the absolute value of the negative DFDO,
(3) when any Regular Workday's calculated DLR would be greater than the Maximum DLR, the Maximum DLR, and,
e. at the end of each Regular Workday, resetting the displayed DLR for the First Regular Workday to the Minimum DLR, and repeating step d., calculating and displaying the new applicable DLRs for each subsequent Regular Workday.

6. The method of claim 4, wherein the DFDO used to calculate the DLR for each Regular Workday out from the First Regular Workday is itself a function of the number of Regular Workdays out from the First Regular Workday.

7. The method of claim 4, wherein the enrolled Service Provider is permitted to log on to the Broker Website and cause the website to display, for a specified calendar time period, an arbitrarily chosen DLR rather than one calculated using the DFDO, after which specified time period the displayed rates resume being calculated based upon the DFDO and DLR in effect immediately before the specified time period.

8. The method of claim 5, wherein the enrolled Service Provider is permitted to log on to the Broker Website and cause the website to display, for a specified calendar time period, an arbitrarily chosen DLR rather than one calculated using the DFDO, after which specified time period the displayed rates resume being calculated based upon the DFDO and DLR in effect immediately before the specified time period.

9. The method of claim 1, wherein the selected Service Provider's acceptance or rejection of an enrolled User's request for a booking on a selected Regular Workday, at the Service Provider's specified labor rate for that date, is posted to the Broker Website, where it is displayed to the User when the User again logs on to the Broker Website.

10. The method of claim 1, further comprising the step of permitting a Service Provider from whom a booking is requested by a User on the Broker Website to communicate with the requesting User via the Broker Website to attempt to negotiate a booking for a different date and time than initially requested, locking in an agreed DLR for performance of requested services on the new agreed date and time

11. The method of claim 1, further comprising the step of permitting a Service Provider from whom a booking is requested and the requesting User to communicate via the Broker Website to negotiate a booking in which the Service Provider provides a total estimated price for all services specified by User.

12. The method of claim 1, further comprising the step of permitting the Service Provider and the User to negotiate via the Broker Website a firm price quote for which the Service Provider commits to perform all services specified by the User.

13. The method of claim 1, wherein, once the agreed services are completed, the Service Provider is permitted to log on to the Broker Website and transmit to the website a bill to the User for those services, which the User can access by logging on to the Broker Website.

14. The method of claim 13, wherein the Broker Website accepts a payment from the User on behalf of the Service Provider.

15. The method of claim 14, wherein the Broker Website deducts a service change for handling the payment transaction before forwarding the User payment to the Service Provider.

16. The method of claim 1, wherein one or more Service Providers enrolled on the Broker Website are mobile Service Providers, performing brokered services at the User's location.

17. The method of claim 1, wherein one or more Service Providers operate from set business locations, to which Users come to receive the Service Providers' brokered services once a booking is accepted.

18. A computerized on-line system for brokering labor of Service Providers to Users, comprising:
a. a digital computer server, with required resources of processing devices, memory storage, user input and output devices, and connection to a public network, and programmed with computer instructions, for performing the following steps,
b. creating on the server a Broker Website, and permitting Service Providers to access the Broker Website over a public network, enroll on the Broker Website as Service Providers, and offer their services to Users on the Broker Website,
c. storing in computer memory profiles of enrolled Service Providers, including their respective offered services, their present and future Regular Workdays, and their time-dependent Daily Labor Rates to be charged on each of those Regular Workdays,
d. permitting Users to access the Broker Website over the public network, to enroll as Users on the Broker Website, and to designate classes of services they desire to purchase, and a time window during which they wish the desired services to be performed,
e. displaying to the enrolled User who has designated such desired services a listing and profiles of those Service Providers that offer, on Regular Workdays falling within the User-designated time window, the services designated by the User, and those Service Providers' respective applicable daily labor rates (DLRs) on each such Regular Workday,
f. permitting the enrolled User to select a Service Provider, and enter on the Broker Website a request for a booking with that Service Provider for performance of the desired work at a requested time on a selected Regular Workday, thereby locking in the Daily Labor Rate that will apply if the selected Service Provider accepts a booking to perform the desired services on the selected date,
g. permitting the selected Service Provider to log in to the Broker Website, to receive the User's booking request, to communicate with the User if necessary to select a mutually agreeable time on the selected date for performance of the work, and to communicate to the User the acceptance or rejection of the booking, locking in the displayed DLR for the selected date when the booking for that date is accepted.

19. The system of claim 18, wherein enrolled Service Providers are permitted to log in to the Broker Website and directly set applicable DLRs for all displayed Regular Workdays.

20. The system of claim 18, wherein enrolled Service Providers are permitted to log in to the Broker Website and set up criteria by which their respective time-dependent DLRs are automatically calculated for a First Regular Workday and for subsequent Regular Workdays.

21. The system of claim 20, wherein one or more Service Providers establish normal, falling, variable Daily Labor Rates for Regular Workdays by the following steps:
a. entering in the computer a Maximum DLR for the Service Provider's services,
b. entering in the computer a Minimum DLR for the Service Provider's services,
c. entering in the computer a positive Discount for Days Out (DFDO) for each Regular Workday out from the first Regular Workday,
d. when a User logs in to the Broker Website to perform a search for a Service Provider, displaying a DLR for each Regular Workday, calculated as follows:
(1) for the first Regular Workday, the Maximum DLR,
(2) for each subsequent Regular Workday, the previous Regular Workday's DLR minus the DFDO,
(3) when any Regular Workday's calculated DLR would be less than the Minimum DLR, the Minimum DLR, and,
e. at the end of each Regular Workday, resetting the displayed DLR for the first Regular Workday to the Maximum DLR, and repeating step d., calculating and displaying the new applicable DLRs for each subsequent Regular Workday.

22. The system of claim 20, wherein one or more Service Providers establish recessionary, rising, variable daily labor rates (DLRs) for Regular Workdays by the following steps:
a. entering in the computer a Minimum DLR for the Service Provider's services,
b. entering in the computer a Maximum DLR for the Service Provider's services,
c. entering in the computer a negative Discount for Days Out (DFDO) for each Regular Workday out from the First Regular Workday,
d. when a User logs in to the Broker Website to perform a search for a Service Provider, displaying a DLR for each Regular Workday, calculated as follows:
(1) for the First Regular Workday, the Minimum DLR,
(2) for each subsequent Regular Workday, the previous Regular Workday's DLR plus the absolute value of the negative DFDO,
(3) when any Regular Workday's calculated DLR would be greater than the Maximum DLR, the Maximum DLR, and,
e. at the end of each Regular Workday, resetting the displayed DLR for the First Regular Workday to the Minimum DLR, and repeating step d., calculating and displaying the new applicable DLRs for each subsequent Regular Workday.

23. The system of claim 21, wherein the enrolled Service Provider is permitted to log on to the Broker Website and cause the computer to display, for a specified calendar time period, an arbitrarily chosen DLR rather than one calculated using the DFDO, after which specified time period the displayed rates resume being calculated based upon the DFDO and DLR in effect immediately before the specified time period.

24. The system of claim 22, wherein the enrolled Service Provider is permitted to log on to the Broker Website and cause the computer to display, for a specified calendar time period, an arbitrarily chosen DLR rather than one calculated using the DFDO, after which specified time period the displayed rates resume being calculated based upon the DFDO and DLR in effect immediately before the specified time period.

25. A computer software product stored on machine-readable media, the product comprising machine executable instructions enabling a digital computer server, with required resources of processing devices, memory storage, user input and output devices, and connection to a public network, to broker labor of Service Providers to Users, by carrying out the steps of:
a. creating on the server a Broker Website, and permitting Service Providers to access the Broker Website over a public network, enroll on the Broker Website as Service Providers, and offer their services to Users on the Broker Website,
b. storing in computer memory profiles of enrolled Service Providers, including their respective offered services, their present and future Regular Workdays, and their time-dependent Daily Labor Rates to be charged on each of those Regular Workdays,
c. permitting Users to access the Broker Website over the public network, to enroll as Users on the Broker Website, and to designate classes of services they desire to purchase, and a time window during which they wish the desired services to be performed,
d. displaying to the enrolled User who has designated such desired services a listing and profiles of those Service Providers that offer, on Regular Workdays falling within the User-designated time window, the services designated by the User, and those Service Providers' respective applicable daily labor rates (DLRs) on each such Regular Workday,
e. permitting the enrolled User to select a Service Provider, and enter on the Broker Website a request for a booking with that Service Provider for performance of the desired work at a requested time on a selected Regular Workday, thereby locking in the Daily Labor Rate that will apply if the selected Service Provider accepts a booking to perform the desired services on the selected date,
f. permitting the selected Service Provider to log in to the Broker Website, to receive the User's booking request, to communicate with the User if necessary to select a mutually agreeable time on the selected date for performance of the work, and to communicate to the User the acceptance or rejection of the booking, locking in the displayed DLR for the selected date when the booking for that date is accepted.

26. The computer software product of claim 25, wherein the program permits enrolled Service Providers to log in to the Broker Website and set up criteria by which their respective time-dependent DLRs are automatically calculated for a First Regular Workday and for subsequent Regular Workdays.

27. The software product of claim 26, wherein the criterion for calculating DLRs for Regular Workdays comprises setting an Initial DLR for the First Regular Workday, a Discount for Days Out (DFDO), and a Final DLR, then calculating the DLR for each Regular Workday following the First Regular Workday by subtracting the DFDO from the preceding Regular Workday's DLR, until the Regular Workday when the Final DLR is reached, and assigning the Final DLR to that and any subsequent Regular Workdays.
